(19) United States
(12) Patent Application Publication
(10) Pub. No.: US 2025/0217063 A1
(43) Pub. Date: Jul. 3, 2025

(54) TEST INSTRUMENT WITH INTEGRATED MODEL DATA BASE

(71) Applicant: Rohde & Schwarz GmbH & Co. KG, Muenchen (DE)

(72) Inventors: Julius SEEGER, Muenchen (DE); Johannes STEFFENS, Muenchen (DE)

(73) Assignee: Rohde & Schwarz GmbH & Co. KG, Muenchen (DE)

(21) Appl. No.: 18/400,820

(22) Filed: Dec. 29, 2023

(51) Int. Cl. G06F 3/06

(52) U.S. Cl. CPC G06F 3/0653; G06F 3/0604; G06F 3/0673

(57) ABSTRACT

A test instrument includes at least one port, wherein the at least one port is configured to receive a measurement signal from a device under test and/or to transmit a test signal to a device under test. The test instrument further includes a testing circuit, wherein the testing circuit is configured to analyze the measurement signal and/or to generate the test signal. The test instrument further includes a memory, wherein the memory includes a model data base, wherein the model data base corresponds to a substitute model of at least the test instrument, and wherein the model data base includes a set of correlated configuration data. The set of correlated configuration data includes operational parameters, wherein the operational parameters describe electrical properties, mechanical properties, hardware properties, software properties, and/or testing properties of the test instrument. The set of correlated configuration data further includes information on interdependencies of the operational parameters.

### FIELD OF THE DISCLOSURE

Embodiments of the present disclosure generally relate to a test instrument. Embodiments of the present disclosure further relate to a method of generating a model of a test instrument and to an electronic device.

### BACKGROUND

With ever-increasing diversity of electronic devices to be tested and of test instruments available to perform the tests on the electronic devices, it becomes increasingly more difficult to choose the right test instrument for a test to be performed.

Usually, an expert is necessary that either knows the correct measurement setup for a specific test to be performed or that performs measurements on a test instrument in order to decide whether the test instrument is suitable for performing the tests.

Accordingly, less experienced users may not be able to establish a correct measurement setup without the help of an expert, which increases both the time and costs for performing measurements.

Thus, there is a need for a test instrument that supports a user in performing measurements on a device under test.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure provide a test instrument. In an embodiment, the test instrument comprises at least one port, wherein the at least one port is configured to receive a measurement signal from a device under test and/or to transmit a test signal to a device under test. The test instrument also comprises a testing circuit, wherein the testing circuit is configured to analyze the measurement signal and/or to generate the test signal. The test instrument further comprises a memory, wherein the memory comprises a model data base, wherein the model data base corresponds to a substitute model of at least the test instrument, and wherein the model data base comprises a set of correlated configuration data. The set of correlated configuration data comprises operational parameters, wherein the operational parameters describe electrical properties, mechanical properties, hardware properties, software properties, and/or testing properties of the test instrument. The set of correlated configuration data further comprises information on interdependencies of the operational parameters.

The term “set of correlated configuration data” is understood to denote a set of data having a plurality of data points that relate to the operational parameters, wherein at least a subset of the data points are correlated with each other, i.e. have interdependencies.

In general, the model data base may describe arbitrary properties of the test instrument. Accordingly, the model data base may comprise additional, uncorrelated data regarding the test instrument. For example, the uncorrelated data may relate to a device footprint, installed hardware options, installed software options, installed firmware options, etc.

Alternatively or additionally, the test instrument may comprise metadata relating to the individual properties, for example to the operational parameters. For example, the metadata may comprise time stamps indicating the time of creation of a data point, a user and/or entity having created the data point, and/or user annotations.

Alternatively or additionally, the model data base, for example the set of correlated configuration data, may comprise reference signals for specific measurements to be conducted, wherein the reference signals may be provided as complex-valued in-phase and quadrature (IQ) data.

The test instrument according to the present disclosure is based on the idea to provide a digital twin of at least the test instrument, namely the substitute model, that is saved in the memory of the test instrument. Based on that digital twin, or more precisely based on the model data base comprising the set of correlated operational parameters, the performance of the test instrument with respect to a measurement to be performed, optimal operational parameters, and/or a correct measurement setup for performing measurements can be obtained, as will be described in more detail below.

Accordingly, the user can be assisted in a plurality of ways in setting up the measurement setup for performing the measurements. As a result, the expertise required from the user is reduced, which reduces the time and costs for performing measurements.

According to an aspect of the present disclosure, the set of correlated configuration data comprises, for example, at least one tensor, wherein the at least one tensor describes the interdependencies of at least a subset of the operational parameters. In general, the at least one tensor may be a tensor of second order or higher. For example, the at least one tensor may be a matrix.

In some embodiments, the set of correlated configuration data may comprise several tensors, wherein each tensor may describe interdependencies of a certain subset of operational parameters.

In some embodiments, uncorrelated data comprised in the model data base may be mapped to at least one further tensor, i.e. the model data base may comprise at least one further tensor describing the uncorrelated data.

In an embodiment of the present disclosure, the operational parameters comprise at least one of a frequency range, an amplitude range, a phase noise range, a dynamic range, a transfer function, a frequency response, an amplitude response, a phase response, a quantity describing a linearity, a compression point, a quantity describing intermodulation, a time resolution, a frequency resolution, an amplitude resolution, a power requirement, a bandwidth, an error vector magnitude as a function of input level, an error vector magnitude as a function of input frequency, a measurement speed, demodulation techniques that can be performed by the test instrument, a calibration technique applicable to the test instrument, a calibration history of the test instrument, standards met by the test instrument, standards not met by the test instrument, or measurement modes of the test instrument. However, it is to be understood that the operational parameters may comprise any other parameters describing an operational status of the test instrument, for example a temperature of the test instrument or of certain components of the test instrument.

Therein and in the following, the term “range” is understood to denote that the operational parameters may comprise upper and/or lower limits for the respective operational parameter. For example, the term “frequency range” implies that the operational parameters may comprise a maximum frequency and/or a minimum frequency processable by the test instrument or certain components of the test instrument.

According to another aspect of the present disclosure, the operational parameters comprise, for example, information on electrical properties, mechanical properties, hardware properties, software properties, and/or testing properties of individual components of the test instrument. In some embodiments, the model data base may comprise several layers of operational data, wherein different layers describe the test instrument in different levels of detail. For example, one layer may describe properties or operational parameters of the test instrument as a whole, a further layer may describe properties or operational parameters of individual circuits of the test instrument, another layer may describe properties or operational parameters of individual components of the individual circuits, etc. Thus, the model data base may describe the test instrument and its components in detail, such that the model data base corresponds to a precise substitute model or a digital twin of the test instrument.

Therein, the model data based may describe generic properties of the test instrument, i.e. properties of the test instrument that are typical for that type of test instrument. These properties of the instrument may be the same for a family of test instruments. For example, such a generic property may be an allowed frequency range or hardware switching points.

Further, the model data base may describe properties of the test instrument that are specific for that test instrument, for example specific properties that are obtained during a calibration of the test instrument.

In a further embodiment of the present disclosure, the operational parameters further comprise information on electrical properties, mechanical properties, hardware properties, software properties, and/or testing properties of further components being connectable to the test instrument. Accordingly, the model data base may comprise information on the complete measurement system for testing a device under test. In some embodiments, the model data base may correspond to a substitute model, i.e. a digital twin, of the measurement system comprising the test instrument.

In some embodiments, the model data base may comprise a plurality of individual substitute models of the test instrument and of the further components being connectable to the test instrument, wherein the plurality of individual substitute models together establish a substitute model of the measurement system, and wherein the individual substitute models may interact with each other.

For example, the further components may comprise cables, electrical connectors, further test instruments, and/or further measurement equipment, such as an external frontend, an RF antenna, a switch matrix, etc.

Another aspect of the present disclosure provides that the model data base is established, for example, as a hierarchical data base. For example, the model data base may be provided in the hierarchical data format (HDF), for example in HDF4 or HDF5. However, it is to be understood that any other suitable type of hierarchical data format may be used.

In an embodiment of the present disclosure, the test instrument further comprises a processing circuit. The processing circuit is configured to receive an analysis request. The analysis request comprises information on a measurement to be performed by the test instrument. The processing circuit is configured to generate performance data based on the analysis request and based on the set of correlated configuration data, wherein the performance data is indicative of a performance of the test instrument with respect to the measurement to be performed.

In general, the performance data may comprise information on operational parameters of the test instrument that are relevant for performing the requested measurement.

In some embodiments, a user may request information on certain properties of the test instrument by the user request, wherein the performance data comprises information on the requested properties. For example, the user may request information on operational parameters of the test instrument under specific operation conditions, such as a phase noise at a certain signal level and/or at a certain frequency.

In some embodiments, the performance data may comprise eligibility data, wherein the eligibility data is indicative of whether the test instrument is suitable for performing the requested measurement. The eligibility data may comprise a binary quantity that indicates whether the test instrument is suitable for performing the requested measurement, i.e. a pass/fail criterion.

Alternatively or additionally, the eligibility data may comprise a quantity indicating the suitability of the test instrument on a continuous or discrete scale. For example, the eligibility data may comprise a percentage indicating the suitability, wherein 100% indicates perfect suitability and 0% indicates that the test instrument is unsuitable for performing the requested measurement. As another example, the eligibility data may comprise a color-coded quantity that is displayed to the user, wherein different colors indicate different levels of suitability.

In some embodiments, the analysis request may be received from a user, for example via a suitable user interface of the measurement instrument. Thus, a user may input the information regarding the measurement to be performed and receives the performance data, such that the user is assisted in setting up the measurement system. In some embodiments, the performance data helps the user in deciding whether the test instrument is suitable for performing the requested measurement. Thus, less expert knowledge is required for performing the requested measurement.

According to an aspect of the present disclosure, the test instrument further comprises, for example, a processing circuit. In some embodiments, the processing circuit is configured to add further data points to the correlated configuration data and/or to replace data points of the correlated configuration data, thereby obtaining an augmented set of correlated configuration data. Thus, it is ensured that the model data base describes the test instrument (and/or further components of the measurement system) in sufficient detail. Moreover, less data points are required in the model data base saved in the memory, as missing data points can be added by the processing circuit.

For example, data points may be added and/or replaced if the current set of correlated configuration data is insufficient in order to decide whether the test instrument is suitable for performing a requested measurement. In other words, adding and/or replacing the data points may be triggered by the analysis request described above. As another example, data points may be added and/or replaced if the current set of correlated configuration data does not describe certain performance aspects of the test instrument requested by a user. In a further example, data points may be added and/or replaced if the current set of correlated configuration data is outdated, for example due to a hardware, firmware, and/or software update applied to the test instrument.

Data points added to the set of correlated configuration data may relate to operational parameters already comprised in the data set. Accordingly, further sampling points for the operational parameters already comprised in the set of correlated configuration data may be added to the set of correlated configuration data. Alternatively or additionally, the data points added to the set of correlated configuration data may relate to new operational parameters, and optionally their interdependencies with the already comprised operational parameters. In other words, new operational parameters may be added to the set of correlated configuration data.

In some embodiments, the processing circuit may be configured to interpolate the correlated configuration data, extrapolate the correlated configuration data, simulate a measurement performed by the test instrument, and/or cause the test instrument to perform a measurement in order to obtain the augmented set of correlated configuration data.

Therein and in the following, the term “interpolation” is understood to not only denote an interpolation in the strict mathematical sense, but rather any mathematical method that is suitable for determining intermediate values of a plurality of data points. For example, the term “interpolation” may comprise mathematical methods such as regression analysis, maximum likelihood estimation, Monte-Carlo simulation, etc.

Moreover, the term “extrapolation” is understood to not only denote an extrapolation in the strict mathematical sense, but rather any mathematical method that is suitable for determining values of data points that lie outside of a plurality of other data points. For example, the term “extrapolation” may comprise mathematical methods such as regression analysis, maximum likelihood estimation, Monte-Carlo simulation, etc.

A further aspect of the present disclosure provides that the processing circuit, for example, is configured to interpolate and/or extrapolate the correlated configuration data only within subsets of the correlated configuration data that correspond to a fixed hardware configuration of the test instrument. In other words, the correlated configuration data is not interpolated and/or extrapolated across hardware switching points where at least one hardware component of the test instrument switches to another operational mode. It has turned out that the accuracy of the interpolated and/or extrapolated data points is increased significantly this way.

In an embodiment of the present disclosure, the test instrument further comprises a processing circuit. The processing circuit is configured to receive an analysis request. The analysis request comprises information on a measurement to be performed by the test instrument. The processing circuit is configured to determine optimized operational parameters of the test instrument based on the analysis request and based on the set of correlated configuration data. Thus, a user is assisted in setting up the test instrument for performing the requested measurement, as the test instrument automatically determines the optimal operational parameters for performing the requested measurement.

In some embodiments, the processing circuit may be configured to generate user instructions for setting the optimized operational parameters. Thus, the user is assisted in setting up the measurement system, for example the test instrument, for optimally performing the requested measurement, as the user instructions for setting the optimized operational parameters are provided to the user.

In some embodiments, the user instructions may comprise information on how to set the correct operational parameters of the test instrument. Alternatively or additionally, the user instructions may comprise information on how to set up the measurement system for performing the requested measurement, such as information on the correct cables, electrical connectors, further test instruments and/or further measurement equipment to be used for the requested measurement. The user instructions may further comprise information on how these components need to be connected to each other. For example, the user instructions may be displayed to the user on a display of the test instrument or on a display connected to the test instrument.

In some embodiments, the performance data described above, the eligibility data described above, and/or the user instructions may be displayed on the display.

In some embodiments, the performance data, the eligibility data, and/or the user instructions may comprise further information on the requested measurement. For example, the performance data, the eligibility data, and/or the user instructions may comprise information on whether the requested measurement can be conducted under the given circumstances (such as available cabling or available further test instruments), reasons why the requested measurement cannot be conducted, constraints under which the requested measurement can be conducted (e.g. a measurement uncertainty that is to be expected), and/or an expected time that the requested measurement will take.

In a certain example, the requested measurement may relate to a measurement under a normed standard, such as a WLAN standard.

According to another aspect of the present disclosure, the processing circuit, for example, is configured to automatically adapt settings of the test instrument based on the determined optimized operational parameters. In other words, the processing circuit may automatically adapt the operational parameters of the test instrument to the optimized operational parameters. Thus, an auto-setting functionality is provided that assists the user in setting up the measurement system or the test instrument.

Embodiments of the present disclosure further provide a method of generating a model of a test instrument. In an embodiment, the method comprises the steps of: receiving configuration data relating to operational parameters of the test instrument, wherein the configuration data comprises information on electrical properties, mechanical properties, hardware properties, software properties, and/or testing properties of the test instrument; determining interdependencies of the operational parameters of the test instrument; and generating and/or adapting a model data base corresponding to a substitute model of at least the test instrument, wherein the model data base comprises a set of correlated configuration data, wherein the correlated configuration data comprises the operational parameters and information on interdependencies of the operational parameters.

The test instrument described above may be configured to perform the method of generating a model of a test instrument. Alternatively or additionally, the method of generating a model of a test instrument may be performed by a suitable electronic device.

Regarding the advantages and further properties of the method, reference is made to the explanations given above with respect to the test instrument, which also hold for the method and vice versa.

In an embodiment of the present disclosure, the operational parameters comprise at least one of a frequency range, an amplitude range, a phase noise range, a dynamic range, a transfer function, a frequency response, an amplitude response, a phase response, a quantity describing a linearity, a compression point, a quantity describing intermodulation, a time resolution, a frequency resolution, an amplitude resolution, a power requirement, a bandwidth, an error vector magnitude as a function of input level, an error vector magnitude as a function of input frequency, a measurement speed, demodulation techniques that can be performed by the test instrument, a calibration technique applicable to the test instrument, a calibration history of the test instrument, standards met by the test instrument, standards not met by the test instrument, or measurement modes of the test instrument. However, it is to be understood that the operational parameters may comprise any other parameters describing an operational status of the test instrument, for example a temperature of the test instrument or of certain components of the test instrument.

In a further embodiment of the present disclosure, the step of determining interdependencies of the operational parameters of the test instrument comprises determining at least one tensor, wherein the at least one tensor describes the interdependencies of at least a subset of the operational parameters. In general, the at least one tensor may be a tensor of second order or higher. For example, the at least one tensor may be a matrix.

In some embodiments, several tensors may be determined, wherein each tensor may describe interdependencies of a certain subset of operational parameters.

In some embodiments, uncorrelated data comprised in the model data base may be mapped to at least one further tensor, i.e. the model data base may comprise at least one further tensor describing the uncorrelated data.

The interdependencies may be determined by at least one of performing measurements, for example on the test instrument or with the test instrument, performing simulations, for example of the test instrument, and/or by suitable mathematical methods such as a correlation analysis of the received configuration data.

The step of generating and/or adapting a model data base corresponding to a substitute model of at least the test instrument may further comprise the step of adding further data points to the correlated configuration data and/or replacing data points of the correlated configuration data, thereby obtaining an augmented set of correlated configuration data. Thus, it is ensured that the model data base describes the test instrument (and/or further components of the measurement system) correctly and in sufficient detail.

For example, data points may be added and/or replaced if the current set of correlated configuration data is insufficient for deciding whether the test instrument is suitable for performing a requested measurement or for generating the performance data described above. In other words, adding and/or replacing the data points may be triggered by the analysis request described above.

As another example, data points may be added and/or replaced if the current set of correlated configuration data does not describe certain performance aspects of the test instrument requested by a user.

In a further example, data points may be added and/or replaced if the current set of correlated configuration data is outdated, for example due to a hardware, firmware, and/or software update applied to the test instrument.

Data points added to the set of correlated configuration data may relate to parameters already comprised in the data set. Accordingly, further sampling points for the operational parameters already comprised in the set of correlated configuration data may be added to the set of correlated configuration data.

Alternatively or additionally, the data points added to the set of correlated configuration data may relate to new operational parameters, and optionally their interdependencies with the already comprised operational parameters. In other words, new operational parameters may be added to the set of correlated configuration data.

According to an aspect of the present disclosure, the correlated configuration data, for example, is interpolated and/or extrapolated, a measurement performed by the test instrument is simulated, and/or a measurement is performed by the test instrument in order to obtain the augmented set of correlated configuration data.

In some embodiments, the correlated configuration data may be interpolated and/or extrapolated only within subsets of the correlated configuration data that correspond to a fixed hardware configuration of the test instrument. In other words, the correlated configuration data is not interpolated and/or extrapolated across hardware switching points where at least one hardware component of the test instrument switches to another operational mode. It has turned out that the accuracy of the interpolated and/or extrapolated data points is increased significantly this way.

In some embodiments, the model data base may comprise the hardware switching points, i.e. the hardware switching points may be operational parameters comprised in the model data base. In some embodiments, the hardware switching points may be operational parameters comprised in the set of correlated configuration data and/or comprised in the additional, uncorrelated data regarding the test instrument.

A further aspect of the present disclosure provides, for example, that the method further comprises the steps of: receiving an analysis request, wherein the analysis request comprises information on a measurement to be performed by the test instrument; and determining optimized operational parameters of the test instrument based on the analysis request and based on the set of correlated configuration data.

In other words, the operational parameters of the test instrument may be automatically adapted to the optimized operational parameter. Thus, an auto-setting functionality is provided that assists the user in setting up the measurement system or the test instrument.

Embodiments of the present disclosure further provide an electronic device. In some embodiments, the electronic device is configured to perform one or more (or all) of the methods described above. For example, the electronic device may be or comprise at least one of a server, a personal computer, a tablet, a laptop, a smartphone or any other suitable type of smart device.

It is also conceivable that the method(s) described above may at least partially be performed by the electronic device described above. The results, i.e. the model data base, the set of correlated configuration data, the determined interdependencies, the augmented set of correlated configuration data, the optimized operational parameters, and/or the performance data, may be transmitted from the electronic device to the test instrument described above, for example via a suitable interface.

In other words, performing individual steps of the method described above or even all steps of the method described above may be outsourced from the test instrument to the electronic device.

Regarding the advantages and further properties of the electronic device, reference is made to the explanations given above with respect to the test instrument and the method, which also hold for the electronic device and vice versa.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a measurement system with a test instrument according to an embodiment of the present disclosure;

FIG. 2 shows a flow chart of a method of generating a model of a test instrument according to an embodiment of the present disclosure;

FIG. 3 schematically shows an example data structure of a model data base;

FIGS. 4A to 4D illustrate different levels of detail described by the model data base; and

FIG. 5 schematically shows an electronic device according to an embodiment of the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

Similarly, any steps described herein may be interchangeable with other steps, or combinations of steps, in order to achieve the same or substantially similar result. Moreover, some of the method steps can be carried serially or in parallel, or in any order unless specifically expressed or understood in the context of other method steps.

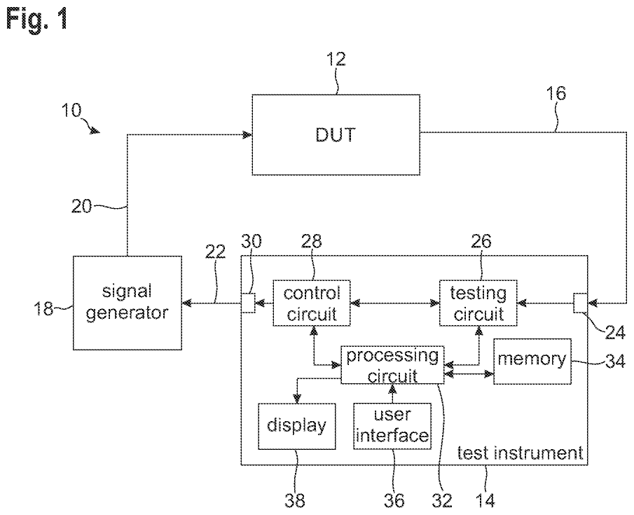

FIG. 1 schematically shows an example of a measurement system 10. In general, the measurement system 10 is configured to perform measurements on a device under test 12 in order to assess the performance of the device under test 12.

In the embodiment shown in FIG. 1, the measurement system 10 comprises a test instrument 14 that is connected with an output of the device under test 12 via a cable 16. In the embodiment shown in FIG. 1, the measurement system 10 may further comprise an external signal generator 18 that is connected with an input of the device under test 12 via a cable 20.

In some embodiments, the signal generator 18 is further connected with the test instrument 14 via a cable 22. The test instrument 14 comprises an input port 24 that is connected with the output of the device under test 12.

The test instrument 14 further comprises a testing circuit 26 that is connected with the input port 24 and that is configured to analyze a measurement signal received from the device under test 12 in order to assess the performance of the device under test 12.

In the example embodiment shown in FIG. 1, the test instrument 14 further comprises a control circuit 28 that is connected with the external signal generator 18 via a control port 30 and the cable 22. In this embodiment, the control circuit 28 is configured to generate a control signal in order to control the signal generator 18 to generate a test signal.

In operation, the test signal is applied to the device under test 12 via the cable 20. The device under test 12 processes the test signal, thereby generating the measurement signal.

In a certain embodiment of the measurement system 10, the device under test 12 may be a two-port electronic component being configured to process a radio-frequency (RF) signal, such as an amplifier. The test instrument 14 may be established as an oscilloscope, as a spectrum analyzer, etc.

It is noted that the measurement system 10 shown in FIG. 1 is purely exemplary. For example, the signal generator 18 may be integrated into the testing circuit 26. As another example, instead of one or more of the cables 16, 20, 22, wireless connections comprising RF transmitter, RF antennas, RF receiver, etc. may be provided.

In some embodiments, it is to be understood that the device under test 12 may be established as any type of electronic device to be tested, an electronic module to be tested, and/or as a system of several electronic devices and/or modules to be tested.

Depending on the device under test 12, the test instrument 14 may be established as a suitable type of instrument. For example, the test instrument 14 may be an audio analyzer, a broadband amplifier, a cellular network analysis instrument, a direction finder, a radar device, a LiDAR device, an electromagnetic compatibility (EMC) test instrument, a test instrument configured to perform field strength tests, a power meter, a counter device, a microwave imaging device, a mobile network testing device, a modular test instrument, a network analyzers, a vector network analyzer, an optical measurement device, an oscilloscope, for example a digital oscilloscope, a volt meter, a radar echo generator, a receiver, for example an RF receiver, a radio transmitter, a satellite monitoring device, a signal analyzer, a spectrum analyzer, a signal generator, for example an arbitrary waveform generator, a spectrum monitoring device, a system components test and measurement instrument, a test instrument being configured to perform tests and/or measurements for broadcasting, a wireless communications tester, a wireless communications test system, etc.

In some embodiments, the measurement system 10 may comprise further components for performing a measurement on the device under test 12, for example cables, electrical connectors, further test instruments, and/or further measurement equipment, such as an external RF frontend, an RF antenna, a switch matrix, etc.

The explanations given hereinafter apply to some of (and in some cases all of) the embodiments described above. However, the example embodiment shown in FIG. 1 is described hereinafter without restriction of generality for illustration purposes.

As shown in FIG. 1, the test instrument 14 further comprises a processing circuit 32 and a memory 34 that is connected with the processing circuit 32. The memory 34 may be established as a non-volatile memory. Moreover, the test instrument 14 comprises a user interface 36 and a display 38 that are each connected to the processing circuit 32.

In general, the user interface 36 may be established as any suitable type of user interface, e.g. as a touch-sensitive display, a display and suitable control knobs, or as any other type of visual user interface and/or auditory user interface.

In the memory 34, a model data base is saved that corresponds to a substitute model of at least the test instrument 14, for example of the test instrument 14 and further components of the measurement system 10.

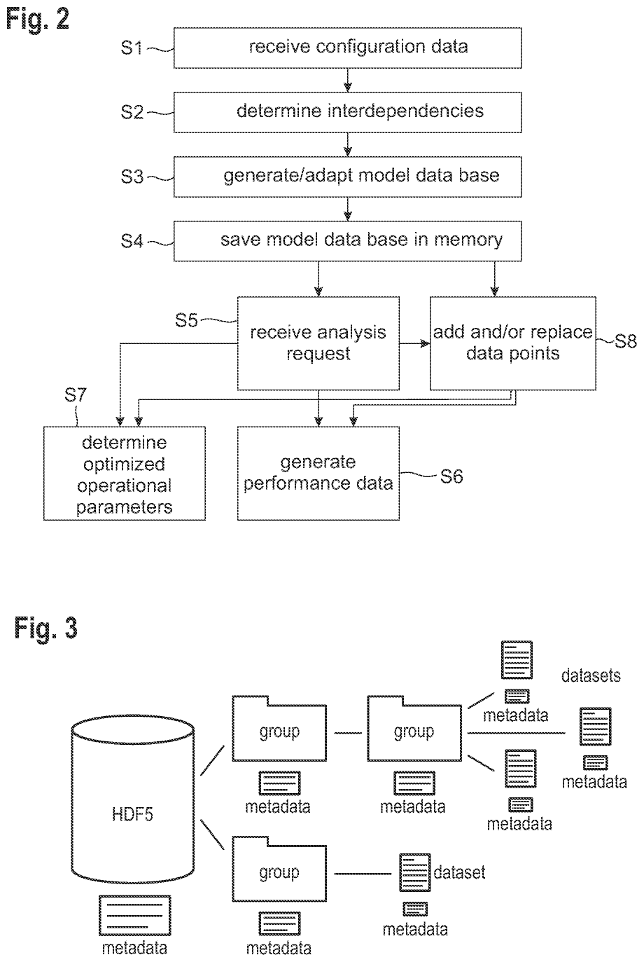

In general, the model data base comprises data relating to the test instrument 14, and optionally relating to the further components of the measurement system 10. The model data base is obtained by a method of generating a model of a test instrument, an example of which is described in the following with reference to FIG. 2.

In some embodiments, the test instrument 14 may be configured to perform the method described hereinafter. In this case, the steps described hereinafter may be performed by, for example, the processing circuit 32 and/or the memory 34.

Configuration data relating to operational parameters of the test instrument 14 is received (step S1).

The configuration data may be received from a database. For example, the configuration data may be downloaded from a server. Alternatively or additionally, the configuration data may be installed on the test instrument 14 by a user.

The configuration data may be obtained from a data sheet describing operational parameters that generally apply to all test instruments of the same type as the test instrument 14. In other words, the configuration data may comprise type-specific operational parameters. Alternatively or additionally, the configuration data may be obtained by way of verification measurements and/or calibration measurements performed on the test instrument 14. In other words, the configuration data may comprise device-specific operational parameters.

In general, the configuration data comprises information on electrical properties, mechanical properties, hardware properties, software properties, and/or testing properties of the test instrument 14. For example, the operational parameters may comprise at least one of a frequency range, an amplitude range, a phase noise range, a dynamic range, a transfer function, a frequency response, an amplitude response, a phase response, a quantity describing a linearity, a compression point, a quantity describing intermodulation, a time resolution, a frequency resolution, an amplitude resolution, a power requirement, a bandwidth, an error vector magnitude as a function of input level, an error vector magnitude as a function of input frequency, a measurement speed, demodulation techniques that can be performed by the test instrument 14, a calibration technique applicable to the test instrument 14, a calibration history of the test instrument 14, standards met by the test instrument 14, standards not met by the test instrument 14, or measurement modes of the test instrument 14.

However, it is to be understood that the operational parameters may comprise any other parameters describing an operational status or other properties of the test instrument 14, for example a temperature of the test instrument 14 or of certain components of the test instrument 14.

Optionally, the configuration data may comprise information on electrical properties, mechanical properties, hardware properties, software properties, and/or testing properties of the further components of the measurement system 10 described above. In the certain example of FIG. 1, the configuration data may comprise information on the properties of the signal generator 18 and/or of the cables 16, 20, 22.

Interdependencies of the received operational parameters are determined (step S2).

For example, at least one tensor may be determined, wherein the at least one tensor describes the interdependencies of at least a subset of the operational parameters. In some embodiments, several tensors may be determined, wherein each tensor may describe interdependencies of a certain subset of the operational parameters.

The interdependencies, i.e. the tensor(s) describing the interdependencies, may be determined by at least one of performing measurements, for example on the test instrument 14 or with the test instrument 14, by performing simulations, for example of the test instrument 14, and/or by suitable mathematical methods such as a correlation analysis applied to the configuration data.

In some embodiments, uncorrelated data comprised in the configuration data may be mapped to at least one further tensor. For example, the uncorrelated data may relate to a device footprint of the test instrument 14, such as installed hardware options of the test instrument 14, installed software options of the test instrument 14, installed firmware options of the test instrument 14, etc.

The model data base corresponding to the substitute model of at least the test instrument 14 is generated and/or adapted based on the received configuration data and based on the determined interdependencies (step S3).

In general, the model data base comprises a set of correlated configuration data, wherein the correlated configuration data comprises the operational parameters and information on interdependencies of the operational parameters, namely the determined tensor(s). Further, the model data base may comprise a set of uncorrelated configuration data, i.e. the uncorrelated data and the further tensor(s) described above.

In some embodiments, the model data base is established as an hierarchical data base. For example, the model data base may be provided in the hierarchical data format (HDF), for example in HDF4 or HDF5. However, it is to be understood that any other suitable type of hierarchical data format may be used.

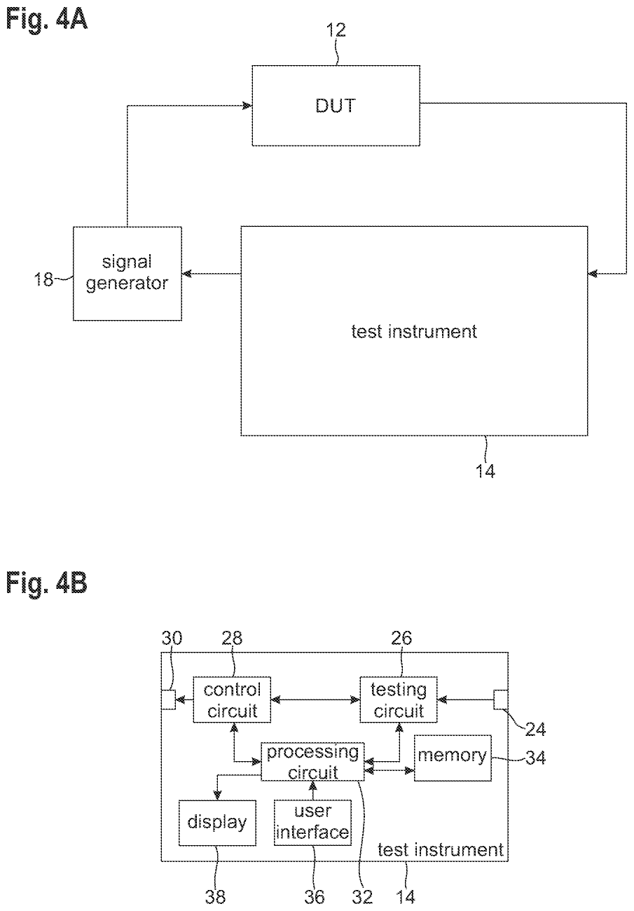

A general structure of the model data base is illustrated in the example shown in FIG. 3, which schematically shows the data structure of the model data base for the particular example of the HDF5 format. As shown in FIG. 3, the model data base comprises groups, which in turn may comprise further groups and/or datasets.

Accordingly, a layered structure is provided that describes the substitute model of at least the test instrument 14 (and optionally the further components of the measurement system 10) in several layers, namely in different levels of detail.

As is further illustrated in FIG. 3, the model data base may further comprise metadata. In some embodiments, the individual groups and/or datasets may comprise metadata, respectively. For example, the metadata may comprise time stamps indicating the time of creation of a data point, a user and/or entity having created the data point, and/or user annotations.

Alternatively or additionally, the model data base, for example the set of correlated configuration data, may comprise reference signals, wherein the reference signals may be provided as complex-valued in-phase and quadrature (IQ) data.

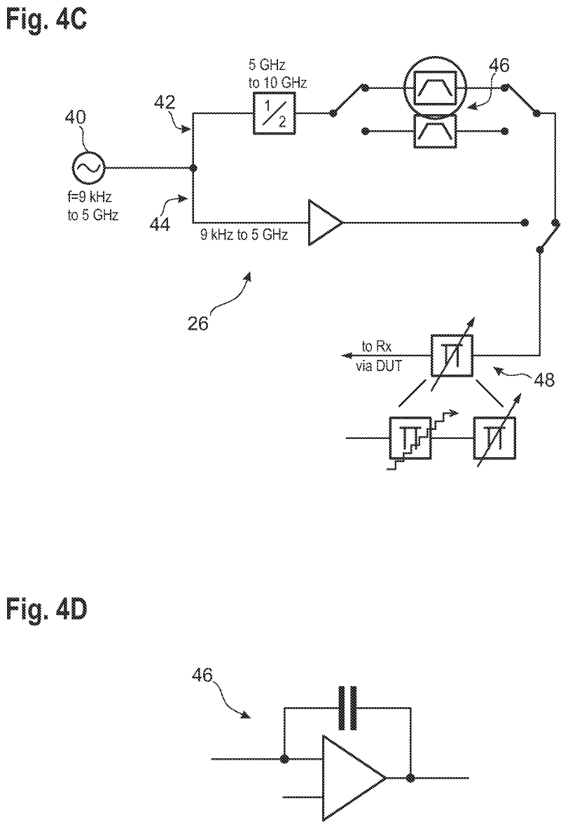

A specific example of the layered structure of the model data base is described hereinafter with respect to FIGS. 4A to 4D.

A first layer of the model data base may describe the measurement system 10 as a whole, e.g. in the level of detail shown in FIG. 4A. In the first layer of the model data base, a plurality of groups relating to the different components of the measurement system 10 may be provided. Accordingly, a first group in the first layer may relate to the test instrument 14, while further groups in the first layer may relate to the further components of the measurement system. For the specific example of the measurement system 10 illustrated in FIG. 1, the further groups may relate to the signal generator 18 and/or the cables 16, 20, 22.

In a second layer, several groups and/or datasets relating to the individual components described by the groups in the first layer may be provided. For example, the first group in the first layer describing the test instrument 14 may comprise a plurality of groups and/or datasets describing the individual circuits of the test instrument 14.

As is illustrated in FIG. 4B, the second layer may describe the test instrument 14 on a block diagram level. Accordingly, the second layer may describe the input port 24, the control port 30, the testing circuit 26, the control circuit 28, the processing circuit 32, the memory 34, the user interface 36, the display 38, and/or other circuits of the test instrument 14.

In a third layer, a plurality of groups and/or datasets relating to the individual components of the circuits described by the second layer may be provided. As is illustrated in FIG. 4C, the third layer may describe the individual circuits on a block diagram level, wherein FIG. 4C exemplarily shows a signal generator portion of a possible variant of the testing circuit 26.

In that specific example, the third layer may inter alia describe a frequency range f of a signal source 40, a frequency range of a first signal path 42, a frequency range of a second signal path 44, pass bands of different band-pass filters 46, and/or attenuation factors provided by different possible combinations of step attenuators 48.

In a fourth layer, a plurality of groups and/or datasets relating to the individual components of the components described by the third layer may be provided. A specific example is illustrated in FIG. 4D, which shows one of the band-pass filters 46 in more detail. The fourth layer may, for example, describe operational parameters of the individual resistors, capacitances, inductances, transistors, diodes, etc. of components described by the third layer.

Of course, further layers describing more details of the components described by the fourth layer may be provided.

It is noted that software provided in the measurement system 10, for example in the test instrument 14 and/or the further components, may be described as a separate layer. Alternatively, the software may be described by separate groups and/or datasets.

The model data base describes at least the test instrument 14, for example the measurement system 10, in increasing level of detail, such that a substitute model, i.e. a digital twin of at least the test instrument 14, for example of the measurement system 10, is provided. In some embodiments, the model data base may comprise a plurality of individual substitute models of the test instrument 14 and of the further components of the measurement system 10. The plurality of individual substitute models together establish a substitute model of the measurement system 10, wherein the individual substitute models may interact with each other.

The model data base obtained and/or adapted as described above is saved in the memory of the test instrument 14 (step S4).

The test instrument 14 may perform any of the steps described hereinafter based on the model data base. If the model data base has already been pre-installed in the memory, the test instrument 14 may, of course, perform the steps described hereinafter independent of steps S1 to S4.

An analysis request may be received by the processing circuit 32 from a user via the user interface 36 (step S5).

The analysis request may comprise information on a measurement to be performed by the test instrument 14 or the measurement system 10. Alternatively or additionally, the analysis request may be a request for information on operational parameters of the test instrument 14 under specific operation conditions, for example a signal to noise ratio at a specific frequency to be analyzed or a jitter at a certain sampling rate.

Performance data may be generated by the processing circuit 32 based on the analysis request and based on the model data base, for example based on the set of correlated configuration data (step S6).

The performance data may comprise information on operational parameters of the test instrument 14 and/or of the measurement system 10 that are relevant for performing the requested measurement. The operational parameters described in the performance data may be selected automatically by the processing circuit 32, for example based on their respective relevance for the requested measurement. The generated performance data may be displayed on the display 38.

Optionally, the performance data comprises eligibility data, wherein the eligibility data comprises information on whether the test instrument 14 or the measurement system 10 is suitable for performing the requested measurement. For example, the eligibility data may comprise a binary quantity that indicates whether the test instrument 14 or the measurement system 10 is suitable for performing the requested measurement, i.e. a pass/fail criterion. Alternatively or additionally, the eligibility data may comprise a quantity indicating the suitability of the test instrument 14 or the measurement system 10 on a continuous or discrete scale. As another example, the eligibility data may comprise a color-coded quantity that is displayed to the user, wherein different colors indicate different levels of suitability.

If the processing circuit 32 determines that the test instrument 14 or the measurement system 10 is not suitable for performing the requested measurement, the performance data may further comprise information on steps necessary in order to adapt the measurement system 10 for performing the requested measurements. For example, the performance data may comprise information on compatible test instruments and/or compatible further components for performing the measurements.

Alternatively or additionally to step S6, optimized operational parameters of the test instrument 14 and/or of the measurement system 10 may be determined by the processing circuit 32 based on the analysis request and based on the model data base, for example based on the set of correlated configuration data (step S7).

In general, the optimized operational parameters may be determined by any suitable algorithm. Alternatively or additionally, the optimized operational parameters may be determined by a suitable machine-learning technique, i.e. by a machine-learning circuit of the processing circuit 32 that is trained to determine the optimized operational parameters. Generally, any suitable deterministic methods and/or non-deterministic methods may be used to determine the optimized operational parameters.

The optimized operational parameters correspond to the optimal operational parameters for performing the requested measurement. In some embodiments, the processing circuit 32 may generate user instructions for setting the optimized operational parameters, and the user instructions may be displayed on the display 38. Alternatively or additionally, the processing circuit 32 may automatically adapt the operational parameters of the test instrument 14 and/or of other components of the measurement system 10 to the optimized operational parameters.

In the example shown in FIG. 1, the processing circuit 32 may cause the control circuit 28 to generate a suitable control signal for the signal generator 18. The signal generator 18 may adapt its operational parameters to the optimized operational parameters based on the control signal.

In some embodiments, the processing circuit 32 may add further data points to the correlated configuration data and/or replace data points of the correlated configuration data, thereby obtaining an augmented set of correlated configuration data (step S8).

For example, the correlated configuration data may be interpolated and/or extrapolated in order to obtain the augmented set of correlated configuration data. Alternatively or additionally, a measurement performed by the test instrument 14 and/or the measurement system 10 may be simulated in order to obtain the augmented set of correlated configuration data. Alternatively or additionally, a measurement may be performed by the test instrument 14 and/or by the measurement system 10 in order to obtain the augmented set of correlated configuration data.

Therein, the correlated configuration data is interpolated and/or extrapolated only within subsets of the correlated configuration data that correspond to a fixed hardware configuration of the test instrument 14 or of the measurement system 10. In other words, the correlated configuration data is not interpolated and/or extrapolated across hardware switching points where at least one hardware component of the test instrument 14 or of the measurement system 10 switches to another operational mode.

For example, operational parameters relating to the testing circuit 26 shown in FIG. 4C are not interpolated and/or extrapolated between a subset relating to the 5 to 10 GHz range and a subset relating to the 9 kHz to 5 GHz range, as the processing circuit is switched from the first signal path 42 to the second signal path 44 when changing the frequency from one frequency range to the other.

Data points may be added and/or replaced if the current set of correlated configuration data is insufficient for deciding whether the test instrument 14 or the measurement system 10 is suitable for performing a requested measurement or for generating the performance data described above. In other words, adding and/or replacing the data points may be triggered by the analysis request described above.

As another example, data points may be added and/or replaced if the current set of correlated configuration data does not describe certain performance aspects of the test instrument 14 or of the measurement system 10 requested by the user. In a further example, data points may be added and/or replaced if the current set of correlated configuration data is outdated, for example due to a hardware, firmware, and/or software update applied to the test instrument 14 or other components of the measurement system 10.

In some embodiments, data points added to the set of correlated configuration data may relate to parameters already comprised in the model data set. Alternatively or additionally, the data points added to the set of correlated configuration data may relate to new operational parameters, and optionally their interdependencies with the already comprised operational parameters.

It is noted that step S6 and/or step S7 described above may be performed based on the augmented set of correlated configuration data.

In the example embodiments described above, the method may at least partially be carried out by the test instrument 14. However, it is to be understood that the method described above may be performed by any other suitable electronic device.

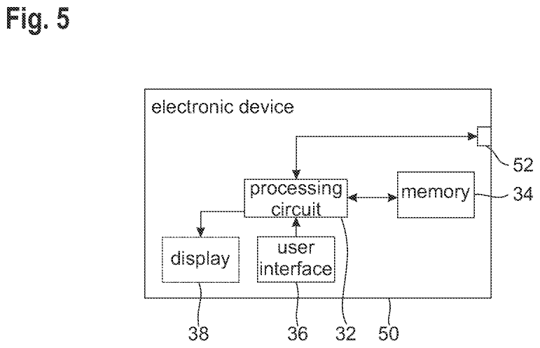

An example embodiment of such an electronic device 50 is illustrated in FIG. 5, wherein like numerals reference components having like functionality for the method described above. For example, the electronic device 50 may be or comprise at least one of a server, a personal computer, a tablet, a laptop, a smartphone or any other suitable type of smart device.

In the embodiment of FIG. 5, the processing circuit 32 of the electronic device may be connected with an input/output interface 52 via which data can be exchanged with other electronic devices. As is further indicated by the dotted lines in FIG. 5, the display 38 may be integrated into the electronic device 50. Alternatively or additionally, an external display may be provided.

In a certain example, the electronic device 50 may be a server, and the user interface 36 may be established as an application, for example a browser application, that can be accessed by a user from an external electronic device. In this case, the electronic device 50 may provide an online configurator that supports a user in setting up a measurement system in any of the ways described above.

Certain embodiments disclosed herein include systems, apparatus, modules, components, units, devices, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implemented the functionality described herein.

Of course, in some embodiments, two or more of these components, or parts thereof, can be integrated or share hardware and/or software, circuitry, etc. In some embodiments, these components, or parts thereof, may be grouped in a single location or distributed over a wide area. In circumstances where the components are distributed, the components are accessible to each other via communication links.

In some embodiments, one or more of the components, such as the signal generator 18, the control circuit 28, the processing circuit 32, etc., referenced above include circuitry programmed to carry out one or more steps of any of the methods disclosed herein. In some embodiments, one or more computer-readable media associated with or accessible by such circuitry contains computer readable instructions embodied thereon that, when executed by such circuitry, cause the component or circuitry to perform one or more steps of any of the methods disclosed herein.

In some embodiments, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In some embodiments, computer-readable media is any medium that stores computer readable instructions, or other information non-transitorily and is directly or indirectly accessible to a computing device, such as processor circuitry, etc., or other circuitry disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In some embodiments, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein. All such combinations or sub-combinations of features are within the scope of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A test instrument, the test instrument comprising
at least one port, the at least one port being configured to receive a measurement signal from a device under test and/or to transmit a test signal to a device under test;
a testing circuit, the testing circuit being configured to analyze the measurement signal and/or to generate the test signal; and
a memory, the memory comprising a model data base, wherein the model data base corresponds to a substitute model of at least the test instrument, wherein the model data base comprises a set of correlated configuration data,
wherein the set of correlated configuration data comprises operational parameters, the operational parameters describing electrical properties, mechanical properties, hardware properties, software properties, and/or testing properties of the test instrument, and
wherein the set of correlated configuration data comprises information on interdependencies of the operational parameters.

2. The test instrument of claim 1, wherein the set of correlated configuration data comprises at least one tensor, wherein the at least one tensor describes the interdependencies of at least a subset of the operational parameters.

3. The test instrument of claim 1, wherein the operational parameters comprise at least one of a frequency range, an amplitude range, a phase noise range, a dynamic range, a transfer function, a frequency response, an amplitude response, a phase response, a quantity describing a linearity, a compression point, a quantity describing intermodulation, a time resolution, a frequency resolution, an amplitude resolution, a power requirement, a bandwidth, an error vector magnitude as a function of input level, an error vector magnitude as a function of input frequency, a measurement speed, demodulation techniques that can be performed by the test instrument, a calibration technique applicable to the test instrument, a calibration history of the test instrument, standards met by the test instrument, standards not met by the test instrument, or measurement modes of the test instrument.

4. The test instrument of claim 1, wherein the operational parameters comprise information on electrical properties, mechanical properties, hardware properties, software properties, and/or testing properties of individual components of the test instrument.

5. The test instrument of claim 1, wherein the operational parameters further comprise information on electrical properties, mechanical properties, hardware properties, software properties, and/or testing properties of further components being connectable to the test instrument.

6. The test instrument of claim 1, wherein the model data base is established as an hierarchical data base.

7. The test instrument of claim 1, further comprising a processing circuit, the processing circuit being configured to receive an analysis request, wherein the analysis request comprises information on a measurement to be performed by the test instrument, and wherein the processing circuit is configured to generate performance data based on the analysis request and based on the set of correlated configuration data, wherein the performance data is indicative of a performance of the test instrument with respect to the measurement to be performed.

8. The test instrument of claim 1, further comprising a processing circuit, wherein the processing circuit is configured to add further data points to the correlated configuration data and/or to replace data points of the correlated configuration data, thereby obtaining an augmented set of correlated configuration data.

9. The test instrument of claim 8, wherein the processing circuit is configured to interpolate the correlated configuration data, extrapolate the correlated configuration data, simulate a measurement performed by the test instrument, and/or cause the test instrument to perform a measurement in order to obtain the augmented set of correlated configuration data.

10. The test instrument of claim 9, wherein the processing circuit is configured to interpolate and/or extrapolate the correlated configuration data only within subsets of the correlated configuration data that correspond to a fixed hardware configuration of the test instrument.

11. The test instrument of claim 1, further comprising a processing circuit, the processing circuit being configured to receive an analysis request, wherein the analysis request comprises information on a measurement to be performed by the test instrument, and wherein the processing circuit is configured to determine optimized operational parameters of the test instrument based on the analysis request and based on the set of correlated configuration data.

12. The test instrument of claim 11, wherein the processing circuit is configured to generate user instructions for setting the optimized operational parameters.

13. The test instrument of claim 11, wherein the processing circuit is configured to automatically adapt settings of the test instrument based on the determined optimized operational parameters.

14. A method of generating a model of a test instrument, the method comprising the steps of
receiving configuration data relating to operational parameters of the test instrument, wherein the configuration data comprises information on electrical properties, mechanical properties, hardware properties, software properties, and/or testing properties of the test instrument;
determining interdependencies of the operational parameters of the test instrument; and
generating and/or adapting a model data base corresponding to a substitute model of at least the test instrument, wherein the model data base comprises a set of correlated configuration data, wherein the correlated configuration data comprises the operational parameters and information on interdependencies of the operational parameters.

15. The method of claim 14, wherein the operational parameters comprise at least one of a frequency range, an amplitude range, a phase noise range, a dynamic range, a transfer function, a frequency response, an amplitude response, a phase response, a quantity describing a linearity, a compression point, a quantity describing intermodulation, a time resolution, a frequency resolution, an amplitude resolution, a power requirement, a bandwidth, an error vector magnitude as a function of input level, an error vector magnitude as a function of input frequency, a measurement speed, demodulation techniques that can be performed by the test instrument, a calibration technique applicable to the test instrument, a calibration history of the test instrument, standards met by the test instrument, standards not met by the test instrument, or measurement modes of the test instrument.

16. The method of claim 14, wherein the step of determining interdependencies of the operational parameters of the test instrument comprises determining at least one tensor, wherein the at least one tensor describes the interdependencies of at least a subset of the operational parameters.

17. The method of claim 14, wherein the step of generating and/or adapting a model data base corresponding to a substitute model of at least the test instrument further comprises the step of adding further data points to the correlated configuration data and/or replacing data points of the correlated configuration data, thereby obtaining an augmented set of correlated configuration data.

18. The method of claim 17, wherein the correlated configuration data is interpolated and/or extrapolated, a measurement performed by the test instrument is simulated, and/or a measurement is performed by the test instrument in order to obtain the augmented set of correlated configuration data.

19. The method of claim 14, further comprising the steps of
receiving an analysis request, wherein the analysis request comprises information on a measurement to be performed by the test instrument; and
determining optimized operational parameters of the test instrument based on the analysis request and based on the set of correlated configuration data.

20. An electronic device, the electronic device being configured to perform the method of claim 14.
